(19) United States
(12) Patent Application Publication
(10) Pub. No.: US 2009/0138846 A1
(43) Pub. Date: May 28, 2009

(54) EXTENDED MACRO RECORDING

(75) Inventors: Misha Shneerson, Redmond, WA (US); David Andrew Whitechapel, Seattle, WA (US); Nirav Shah, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/944,461

(22) Filed: Nov. 23, 2007

(51) Int. Cl. G06F 9/44

(52) U.S. Cl. 717/106

(57) ABSTRACT

Various technologies and techniques are disclosed for extending macro recordings. A request is received to record a macro in a macro-enabled application using an original recording engine. The request is intercepted, and the macro is recorded using a separate recording engine than the original recording engine. To record the macro using the separate recording engine, a vtable is intercepted from a macro recording mechanism used by an original recording engine. Calls contained in the vtable are then redirected to one or more functions in a separate recording engine. The macro is output to a different format than an original format of the original recording engine.

### BACKGROUND

Macros allow a user to record a series of steps that can then be re-applied at a later time to save time in repeating the steps again. In a typical macro recording work flow, the user selects a record button, performs a series of steps within a program, and then selects a stop button. The steps that the user takes in the user interface from the time the record option is selected until the time that the stop option is selected gets captured, and then saved in a macro. For example, the menu selections, document navigation, and other actions taken by the user in the document are recorded in the macro. The user can then open the document or template that contains this macro and run the macro at a later time so that those steps do not have to be repeated.

For example, users of MICROSOFT® Office Word, MICROSOFT® Office EXCEL®, or other MICROSOFT® Office programs can record macros using Visual Basic for Applications (VBA). When VBA macros are recorded, the VBA source code that is used to automate the tasks that were recorded gets saved. This VBA source code is typically embedded directly within the document in which it was recorded or within a document template that was selected.

By storing the macro code directly in the document, it is difficult to maintain the macro independently of the document. It is also difficult to apply source-code control over the document, to re-use the macro in another application, and so on. Usage of the macro also becomes restricted to the language in which the macro was written.

### SUMMARY

Various technologies and techniques are disclosed for extending macro recordings. A request is received to record a macro in a macro-enabled application using an original recording engine. The request is intercepted, and the macro is recorded using a separate recording engine than the original recording engine. The macro is output to a different format than an original format of the original recording engine.

In one implementation, to record the macro using the separate recording engine, a vtable is intercepted from a macro recording mechanism used by an original recording engine. Calls contained in the vtable are then redirected to one or more functions in a separate recording engine. The macro is output to a different format than an original format of the original recording engine.

In one implementation, a method for extending VBA macro recordings is disclosed. A request is received to record a macro in a VBA-enabled application using an original recording engine. A vtable of a VBA macro recording mechanism used by the original recording engine is intercepted. Calls contained in the vtable are redirected to one or more functions in a separate recording engine. The one or more functions cause the macro to be output in one or more source code files that are separate from the VBA-enabled application, and that are in a separate format than VBA.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a system for extending macro recordings.

FIG. 2 is a process flow diagram for one implementation illustrating the stages involved in intercepting a macro recording and replacing the recording with code of a different format.

FIG. 3 is a process flow diagram for one implementation illustrating the stages involved in supplementing an existing macro recording process by also recording the macro into code of a different format.

FIG. 4 is a diagrammatic view of a macro recording interception mechanism of one implementation.

FIG. 5 is a process flow diagram for one implementation illustrating the stages involved in determining the macro interface to intercept for providing extended macro recording.

FIG. 6 is a diagrammatic view of the hijacking of a vtable to perform extended macro recording.

FIG. 7 is a process flow diagram for one implementation illustrating the stages involved in hijacking a macro recording engine vtable to replace the recording commands with the commands for the separate macro recording engine.

FIG. 8 is a process flow diagram for one implementation illustrating the stages involved in hijacking a macro recording engine vtable to supplement the recording commands with the commands for the separate macro recording engine.

FIG. 9 is a diagrammatic view of a computer system of one implementation.

### DETAILED DESCRIPTION

The technologies and techniques herein may be described in the general context as an application that extends macro recordings, but the technologies and techniques also serve other purposes in addition to these. In one implementation, one or more of the techniques described herein can be implemented as features within a macro-enabled program such as MICROSOFT® Office Word, MICROSOFT® Office EXCEL®, or from any other type of program or service that provides and/or interacts with macro recordings.

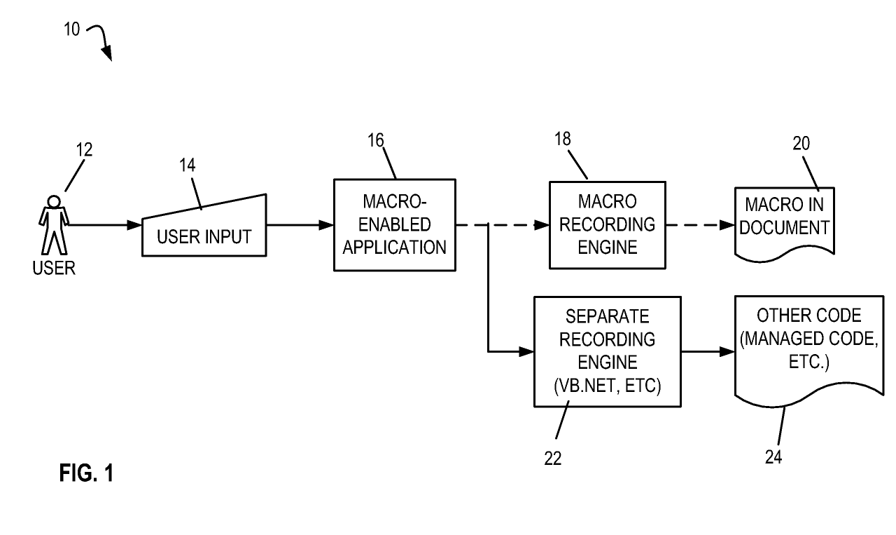

As shown in FIG. 1, in one implementation, an extended macro recording system 10 is provided. The term “macro” as used herein is meant to include a series of actions that are recorded into a format that can be re-executed at a later time to repeat the series of actions again. A user 12 performs some action 14 o record a macro within a macro-enabled application 16. As shown by the dotted lines on FIG. 1, an original macro recording engine 18 is what would normally then be used to record the macro 20 in the document. The term “original macro recording engine” as used herein is meant to include a macro recording engine that is designed to be the normal source for recording the macro. Using some or all of the techniques discussed herein, requests to the original recording engine 18 are intercepted, and the macro is recorded using a separate recording engine 22. The term “separate recording engine” as used herein is meant to include a macro recording engine that is separate from an original macro recording engine.

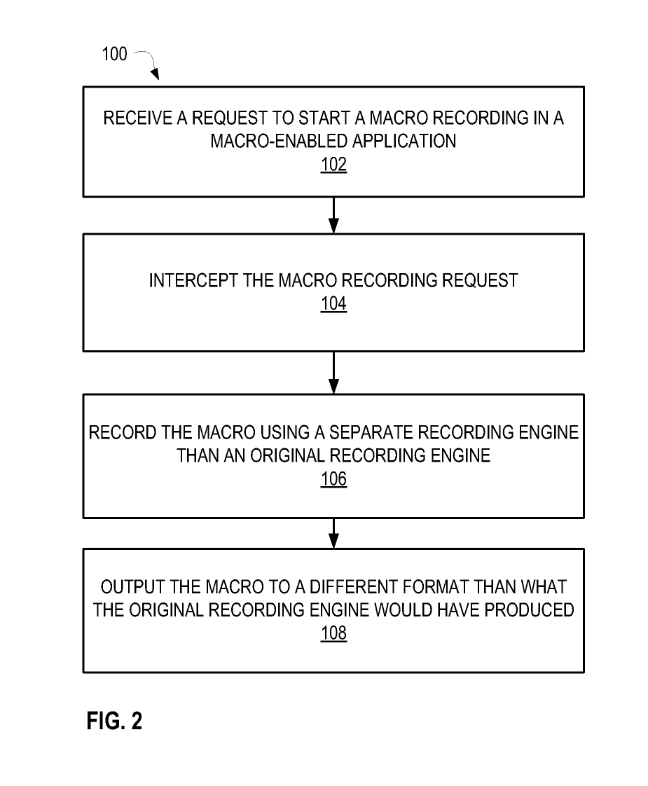

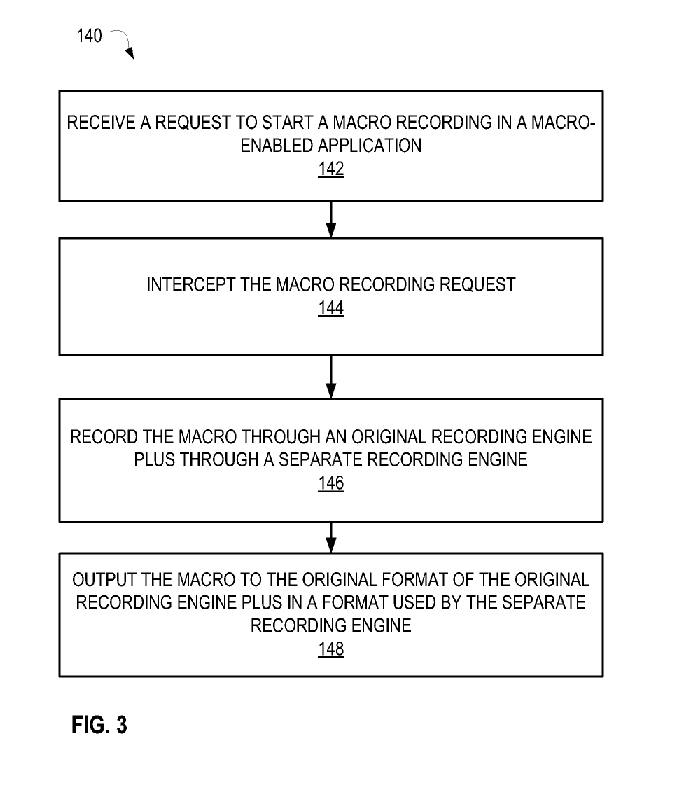

In one implementation discussed in further detail in FIG. 2, the separate recording engine 22 is used instead of the original macro recording engine 18. In another implementation discussed in FIG. 3, the original macro recording engine 18 and the separate macro recording engine 22 are both used to record the macro. The separate recording engine 22 records the macro to code 24 in a different format than an original format of the original recording engine. In one implementation, the different format is embedded within the source document in a similar fashion as the original format would have been embedded. In another implementation, the different format is placed in one or more separate source code files that can optionally be re-used with other applications separately from the macro. For example, if the separate format is Visual Basic.NET, then that Visual Basic.NET source code could also be used with other Visual Basic.NET source code files or projects that were created by a software development program. In other words, by enabling the macro to be recorded into a separate file, the source code of the macro can more easily be re-used by other applications.

In one implementation, VBA macros (or other non-managed code macros) can be intercepted and recorded into a managed code format such as MICROSOFT® Visual Basic.NET, C#, other managed code formats, or other non-managed code formats. The term “managed code” as used herein is meant to include computer program code that executes under the management of a virtual machine. Managed code is contrasted with unmanaged code, which is executed directly by a computer's central processing unit. These various techniques for extending macro recordings using a separate recording engine will now be described in further detail in FIGS. 2-9 herein.

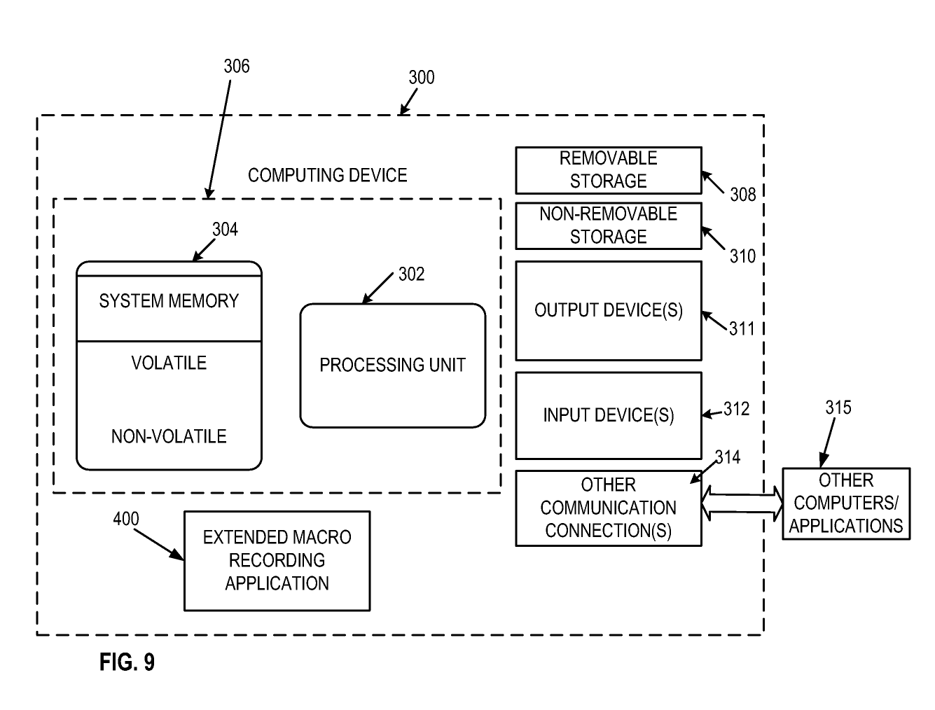

Turning now to FIGS. 3-8 with continued reference to FIGS. 1-2, the stages for implementing one or more implementations of extended macro recording application are described in further detail. In some implementations, the processes of FIG. 3-8 are at least partially implemented in the operating logic of computing device 300 (of FIG. 9).

FIG. 2 is a process flow diagram 100 for one implementation illustrating the stages involved in intercepting a macro recording and replacing the recording with code of a different format. A request is received from a user (or programmatically) to start a macro recording in a macro-enabled application (stage 102). The system intercepts the macro recording request (stage 104) and records the macro using a separate recording engine than an original recording engine (stage 106). The macro is output to a different format than what the original recording engine would have produced (stage 108). In the example discussed in FIG. 2, the separate macro recording engine takes over and records the macro into the different format that is specified by the separate macro recording engine. The original recording engine does not end up recording the macro as it normally would have. In another implementation, as discussed next in FIG. 3, the original recording engine and the separate recording engine are both used.

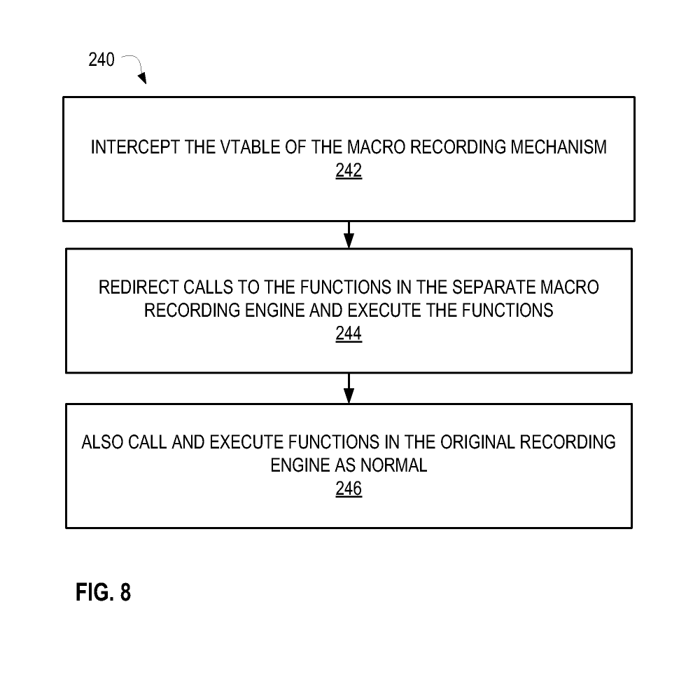

FIG. 3 is a process flow diagram 140 for one implementation illustrating the stages involved in supplementing an existing macro recording process by also recording the macro into code of a different format. A request is received from a user (or programmatically) to start a macro recording in a macro-enabled application (stage 142). The system intercepts the macro recording request (stage 144) and records the macro through an original recording engine plus through a separate recording engine (stage 146). In one implementation, the separate macro recording engine manages the interception of commands and calls commands in the separate macro recording engine as well as in the original recording engine to create both macros in the separate format and the original format. Additional details on some techniques that can be used to perform the interception and recording through both engines are described in further detail in FIG. 8. The macro is then output in the original format of the original recording engine plus in a format used by the separate recording engine (stage 148). For example, in the case of a VBA-enabled macro application, the macro is recorded in the original VBA format, as well as in a format specified by the separate recording engine, which can be a managed code format (such as Visual Basic.NET, C#, etc.) or a non-managed code format.

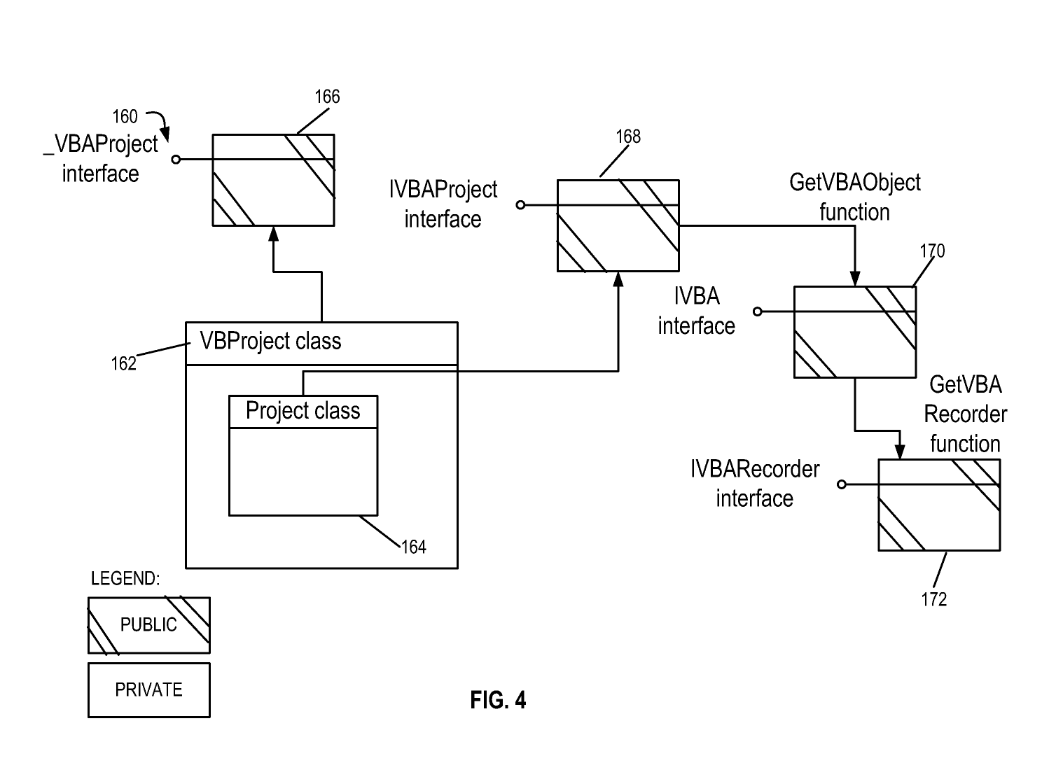

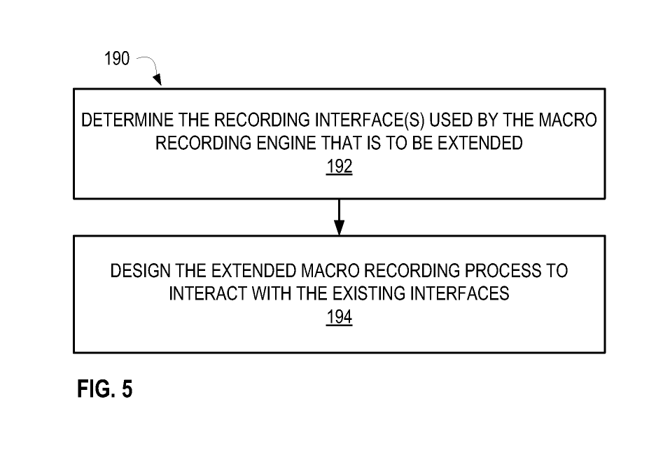

FIG. 4 is a diagrammatic view of a macro recording interception mechanism of one implementation that uses VBA. While the example shown is specific to VBA, the concepts discussed with respect to FIG. 4 can apply to macro-enabled languages other than VBA. VBA is just used as an example to further illustrate the concepts herein. In the example shown in FIG. 3, the VBA-enabled application publicly exposes a_VBAProject interface 160. The macro-enabled application implements this interface in a class (VBProject class 162). This VBProject class 162 has a project member 164. From the project member 164, an IVBAProject interface 168 can be obtained. The IVBAProject interface defines a GetVBAObject function 170. The GetVBAObject function 170 returns an IVBA interface. The IVBA interface defines a GetVBARecorder function 172. The GetVBARecorder function 172 returns an IVBARecorder interface. As described in further detail in FIG. 5, once the interface of the original recording engine is determined, then techniques can be used to intercept the recording mechanism and replace or supplement it.

FIG. 5 is a process flow diagram 190 for one implementation illustrating the stages involved in determining the macro interface to intercept for providing extended macro recording. The recording interface(s) used by the macro recording engine that is to be extended are identified (stage 192). In one implementation, the extended macro recording process is designed to interact with the existing interfaces (stage 194).

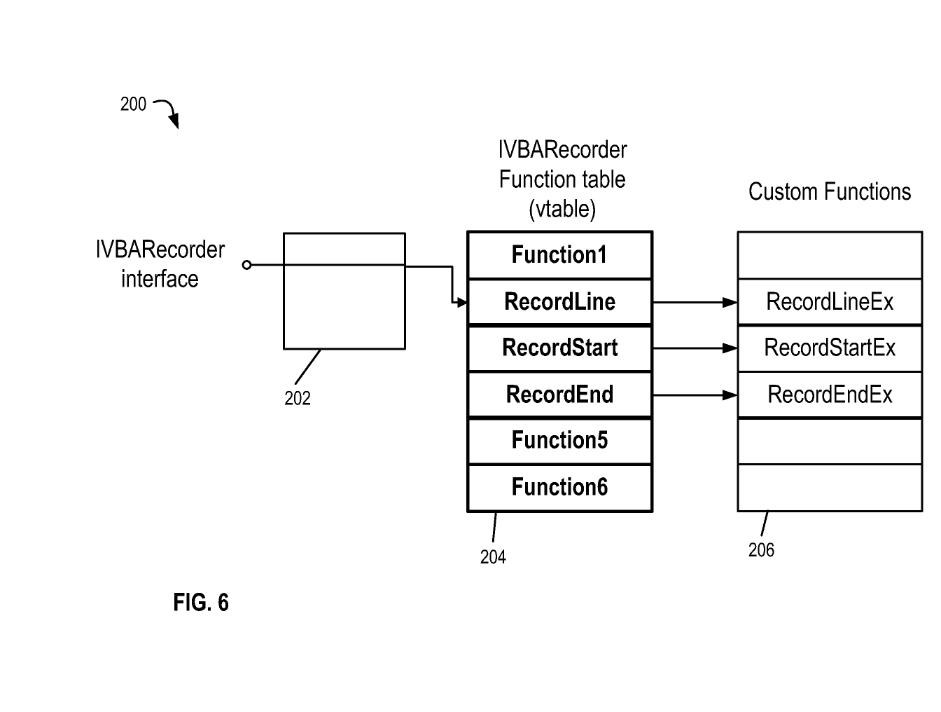

FIG. 6 is a diagrammatic view of the hijacking of a vtable to perform extended macro recording. The term “vtable” as used herein is meant to include a virtual function table that processes calls by position. The starting address of the vtable plus an offset for each function serves as the position. With vtables, function calls are not actually directly made by name, but are made by an address, just like in the underlying machine code. While some of the examples discussed herein illustrate how the extended macro recording system can be used with vtables, some or all of the techniques could also be used with traditional function calls where functions are referenced by name.

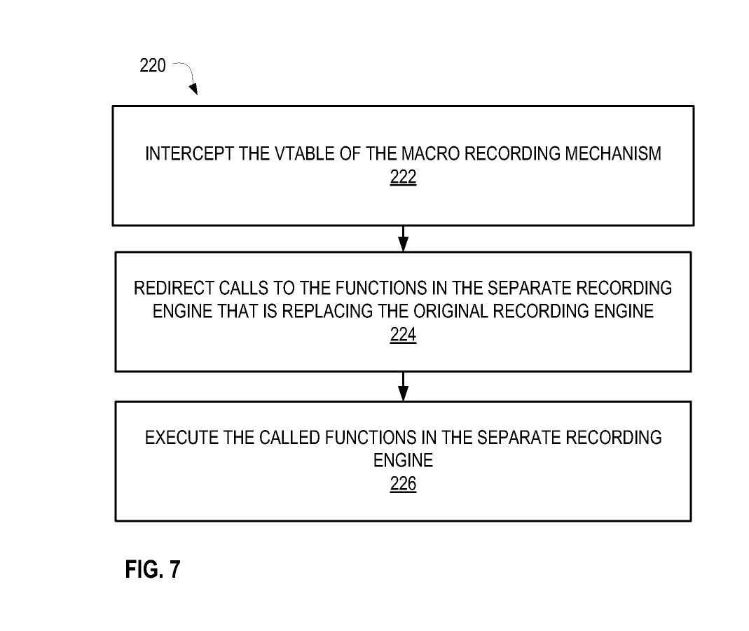

Once the interface 202 of the original macro recording engine is identified (as described in FIGS. 4 and 5), the vtable 204 of the macro recording engine (IVBARecorder or other) can then be hijacked so that calls can be redirected to alternative functions 206 instead of or in addition to the original functions. In the example shown in FIG. 6 for VBA, there is a RecordLine function, a RecordStart function, and a RecordEnd function. These functions are used in VBA to record the code associated with the selected command, and to start and stop the macro recording process, respectively. In other implementations, some, fewer, and/or additional functions could be used. FIG. 7 describes an implementation where the redirection is made to alternative functions instead of the original functions, and FIG. 8 describes an implementation where the redirection is made to alternative functions in addition to the original functions.

FIG. 7 is a process flow diagram 200 for one implementation illustrating the stages involved in hijacking the macro recording engine vtable to replace the recording commands with the commands for the separate macro recording engine. The vtable of the original macro recording mechanism is intercepted (stage 222). The calls are redirected to the functions in the separate recording engine that is replacing the original recording engine (stage 224). The system executes the called functions in the separate recording engine (stage 226). In other words, the macro recording commands that would have typically been called in the original recording engine to record the user's input are redirected to functions in the separate recording engine that carries out the desired recording task instead. As described in FIG. 8, another implementation uses executes the commands in the original macro recording engine and the separate recording engine.

FIG. 8 is a process flow diagram 220 for one implementation illustrating the stages involved in hijacking the macro recording engine vtable to supplement the recording commands with the commands for the separate macro recording engine. The vtable of the original macro recording mechanism is intercepted (stage 242). Calls are redirected to the functions in the separate macro recording engine, and those functions in the separate macro recording engine are executed (stage 244). From within the functions of the separate macro recording engine, the functions of the original macro recording engine are also called (stage 246). In this way, the separate macro recording engine takes control over the recording, but still calls the original functions in addition to the separate functions. As an end result, the original macro is produced in the original format, plus a separate macro is generated in the separate format. In another implementation, calls can be made to both the original functions and the separate functions to produce both macros.

In another implementation, once the vtable of the original macro recording mechanism has been hijacked, any operation can be performed instead of or in addition to the original macro recording, whether or not that operation is related to recording macros. For example, logging functionality, performance counters, a business workflow, or another operation that is related to the user's input during the macro recording operation could be performed.

As shown in FIG. 9, an exemplary computer system to use for implementing one or more parts of the system includes a computing device, such as computing device 300. In its most basic configuration, computing device 300 typically includes at least one processing unit 302 and memory 304. Depending on the exact configuration and type of computing device, memory 304 may be volatile (such as RAM), non-volatile (such as ROM, flash memory, etc.) or some combination of the two. This most basic configuration is illustrated in FIG. 9 by dashed line 306.

Additionally, device 300 may also have additional features/functionality. For example, device 300 may also include additional storage (removable and/or non-removable) including, but not limited to, magnetic or optical disks or tape. Such additional storage is illustrated in FIG. 9 by removable storage 308 and non-removable storage 310. Computer storage media includes volatile and nonvolatile, removable and non-removable media implemented in any method or technology for storage of information such as computer readable instructions, data structures, program modules or other data. Memory 304, removable storage 308 and non-removable storage 310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 300. Any such computer storage media may be part of device 300.

Computing device 300 includes one or more communication connections 314 that allow computing device 300 to communicate with other computers/applications 315. Device 300 may also have input device(s) 312 such as keyboard, mouse, pen, voice input device, touch input device, etc. Output device(s) 311 such as a display, speakers, printer, etc. may also be included. These devices are well known in the art and need not be discussed at length here. In one implementation, computing device 300 includes an extended macro recording application 400 that provides some or all of the techniques discussed in FIGS. 1-8 herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
receiving a request to record a macro in a macro-enabled application using an original recording engine;
intercepting the request;
recording the macro using a separate recording engine than the original recording engine; and
outputting the macro to a different format than an original format of the original recording engine.

2. The computer-readable medium of claim 1, wherein the original format is unmanaged code and the different format is managed code.

3. The computer-readable medium of claim 1, wherein the original format is VBA.

4. The computer-readable medium of claim 1, further having computer-executable instructions for causing a computer to perform steps comprising:
outputting the macro to the original format in addition to the different format.

5. The computer-readable medium of claim 4, wherein the original format is embedded in a document managed by the macro-enabled application.

6. The computer-readable medium of claim 1, wherein the original format is embedded in a document managed by the macro-enabled application.

7. The computer-readable medium of claim 1, wherein the different format is stored in one or more files that are separate from the macro-enabled application.

8. The computer-readable medium of claim 1, wherein the different format is stored in a document managed by the macro-enabled application.

9. A method for replacing macro recording commands with commands for a separate macro recording engine comprising the steps of:
intercepting a vtable of a macro recording mechanism used by an original recording engine;
redirecting calls contained in the vtable to one or more functions in a separate recording engine; and
executing the one or more functions in the separate recording engine, thereby causing a macro to be recorded using the separate recording engine.

10. The method of claim 9, further comprising the steps of:
prior to intercepting the vtable, identifying a recording interface used by the original recording engine.

11. The method of claim 10, further comprising the steps of:
using the recording interface to identify the vtable.

12. The method of claim 10, wherein the interface is an IVBARecorder interface.

13. The method of claim 9, wherein the separate recording engine is replacing the original recording engine.

14. The method of claim 9, wherein the vtable is an IVBARecorder function table.

15. The method of claim 9, wherein at least one of the commands is a record line command.

16. The method of claim 9, wherein at least one of the commands is a record start command.

17. The method of claim 9, wherein at least one of the commands is a record end command.

18. The method of claim 9, further comprising the steps of:
calling original functions used by the original recording engine from the one or more functions in the separate recording engine.

19. A method for extending VBA macro recording comprising the steps of:
receiving a request to record a macro in a VBA-enabled application using an original recording engine;
intercepting a vtable of a VBA macro recording mechanism used by the original recording engine; and
redirecting calls contained in the vtable to one or more functions in a separate recording engine, the one or more functions causing the macro to be output in one or more source code files that are separate from the VBA-enabled application, and in a different format than VBA.

20. The method of claim 19, wherein the one or more source code files are output in a managed code format.
